(19) United States
(12) Patent Application Publication
(10) Pub. No.: US 2026/0332322 A1
(43) Pub. Date: Oct. 22, 2026

(54) FREQUENCY HOPPING FOR ULTRA-WIDEBAND COMMUNICATIONS

(71) Applicant: QUALCOMM Incorporated, San Diego, CA (US)

(72) Inventors: Pooria PAKROOH, SAN MARCOS, CA (US); Bin TIAN, San Diego, CA (US); Le Nguyen LUONG, San Diego, CA (US); Koorosh AKHAVAN, San Diego, CA (US)

(21) Appl. No.: 19/185,194

(22) Filed: Apr. 21, 2025

(51) Int. Cl. H04L 5/00; H04B 1/00; H04L 25/02

(52) U.S. Cl. CPC H04L 5/0012; H04B 1/0092; H04L 25/0202

(57) ABSTRACT

This disclosure provides methods, components, devices and systems for frequency hopping for ultra-wideband (UWB) communications. Some aspects more specifically relate to frequency hopping within a given duration (for example, 1 millisecond) for UWB communications to increase communication range and/or throughput while complying with a power spectral density limitation. In some examples, to implement frequency hopping, the transmitting and receiving wireless communication devices may exchange control signaling that indicates or configures a frequency hopping scheme for communication via UWB. For example, the frequency hopping scheme may indicate which frequency ranges (for example, within UWB) will be used for subsequent packets transmitted within a given time duration (for example, a first frequency range for a temporally first packet, a second frequency range for a temporally second packet, etc.) and the relative timing of the transmission of the subsequent packets.

### TECHNICAL FIELD

This disclosure relates generally to wireless communication and, more specifically, to frequency hopping for ultra-wideband (UWB) communications.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure can be implemented in a method for wireless communications by a wireless communication device. The method may include communicating control signaling that indicates a frequency hopping scheme for ultra-wideband (UWB) communications, where the frequency hopping scheme is indicative of timing of subsequent transmissions via a first frequency range and a second frequency range within a threshold duration, transmitting a first packet via the first frequency range in accordance with the frequency hopping scheme, and transmitting, after a time gap after transmission of the first packet, a second packet via the second frequency range in accordance with the frequency hopping scheme, where the transmission of the first packet and transmission of the second packet are within a time period that satisfies the threshold duration.

Another innovative aspect of the subject matter described in this disclosure can be implemented in a wireless communication device for wireless communications. The wireless communication device may include a processing system that includes processor circuitry and memory circuitry that stores code. The processing system may be configured to cause the wireless communication device to communicate control signaling that indicates a frequency hopping scheme for UWB communications, where the frequency hopping scheme is indicative of timing of subsequent transmissions via a first frequency range and a second frequency range within a threshold duration, transmit a first packet via the first frequency range in accordance with the frequency hopping scheme, and transmit, after a time gap after transmission of the first packet, a second packet via the second frequency range in accordance with the frequency hopping scheme, where the transmission of the first packet and transmission of the second packet are within a time period that satisfies the threshold duration.

Another innovative aspect of the subject matter described in this disclosure can be implemented in a wireless communication device for wireless communications. The wireless communication device may include means for communicating control signaling that indicates a frequency hopping scheme for UWB communications, where the frequency hopping scheme is indicative of timing of subsequent transmissions via a first frequency range and a second frequency range within a threshold duration, means for transmitting a first packet via the first frequency range in accordance with the frequency hopping scheme, and means for transmitting, after a time gap after transmission of the first packet, a second packet via the second frequency range in accordance with the frequency hopping scheme, where the transmission of the first packet and transmission of the second packet are within a time period that satisfies the threshold duration.

Another innovative aspect of the subject matter described in this disclosure can be implemented in a non-transitory computer-readable medium storing code for wireless communications. The code may include instructions executable by one or more processors to communicate control signaling that indicates a frequency hopping scheme for UWB communications, where the frequency hopping scheme is indicative of timing of subsequent transmissions via a first frequency range and a second frequency range within a threshold duration, transmit a first packet via the first frequency range in accordance with the frequency hopping scheme, and transmit, after a time gap after transmission of the first packet, a second packet via the second frequency range in accordance with the frequency hopping scheme, where the transmission of the first packet and transmission of the second packet are within a time period that satisfies the threshold duration.

In some examples of the method, wireless communication devices, and non-transitory computer-readable medium described herein, the timing includes a fixed gap duration between the subsequent transmissions and the time gap includes the fixed gap duration.

Some examples of the method, wireless communication devices, and non-transitory computer-readable medium described herein may further include operations, features, means, or instructions for transmitting the first packet during a first time slot and transmitting the second packet during a second time slot, where the timing includes a slot duration of the first time slot and the second time slot.

In some examples of the method, wireless communication devices, and non-transitory computer-readable medium described herein, the first packet includes a first synchronization portion, a first start of frame delimiter (SFD), a first physical layer header, and a first data payload, the first synchronization portion associated with detection of the first packet, carrier frequency offset (CFO) estimation, and channel estimation for the first frequency range; and the second packet includes a second synchronization portion, a second SFD, a second physical layer header, and a second data payload, the second synchronization portion associated with detection of the second packet, CFO estimation, and channel estimation for the second frequency range.

In some examples of the method, wireless communication devices, and non-transitory computer-readable medium described herein, the first packet includes a first synchronization portion, a SFD, a physical layer header, and a first data payload, the first synchronization portion associated with detection of the first packet, CFO estimation, and channel estimation for the first frequency range; and the second packet includes a second synchronization portion and a second data payload, the second synchronization portion associated with channel estimation for the second frequency range.

Some examples of the method, wireless communication devices, and non-transitory computer-readable medium described herein may further include operations, features, means, or instructions for transmitting, after a second time gap after transmission of the second packet, a third packet via a third frequency range in accordance with the frequency hopping scheme, where: the frequency hopping scheme may be indicative of the timing of subsequent transmissions via the first frequency range, the second frequency range, and the third frequency range within the threshold duration; and the transmission of the first packet, the transmission of the second packet, and transmission of the third packet may be within the time period that satisfies the threshold duration.

In some examples of the method, wireless communication devices, and non-transitory computer-readable medium described herein, the first packet includes a first synchronization portion, a SFD, and a physical layer header, the first synchronization portion associated with detection of the first packet, CFO estimation, and channel estimation for the first frequency range; the second packet includes a second synchronization portion and a first data payload, the second synchronization portion associated with channel estimation for the second frequency range; and the third packet includes a third synchronization portion and a second data payload, the third synchronization portion associated with channel estimation for the third frequency range.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows examples resource diagrams that show timing of signaling that supports frequency hopping for ultra-wideband (UWB) communications.

FIG. 3 shows an example of a resource diagram that shows timing of signaling that supports frequency hopping for UWB communications.

FIG. 4 shows an example of a resource diagram that shows timing of signaling that supports frequency hopping for UWB communications.

FIG. 5 shows an example of a resource diagram that shows timing of signaling that supports frequency hopping for UWB communications.

FIG. 6 shows an example of a resource diagram that shows timing of signaling that supports frequency hopping for UWB communications.

FIG. 7 shows a block diagram of an example wireless communication device that supports frequency hopping for UWB communications.

FIG. 8 shows a flowchart illustrating an example process performable by or at a wireless communication device that supports frequency hopping for UWB communications.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (W PAN), a wireless local area network (WLAN), a wireless wide area network (WWAN), a wireless metropolitan area network (W MAN), a non-terrestrial network (NTN), or an internet of things (IOT) network.

In some wireless communication networks, a first wireless communication device (for example, a station (STA) or an access point (AP)) may communicate via a radio access technology (RAT) that supports ultra-wideband (UWB) with a second wireless communication device. For example, communication via UWB may involve transmissions via 500 MHz frequency bands (for example, channels). Transmissions over UWB may be energy-limited (for example, by regulatory bodies such as the European Telecommunication Standards Institute (ETSI) and/or the Federal Communications Commission (FCC)), where transmissions may not exceed a power spectral density (PSD) limit per channel over a given time duration (for example, averaged over 1 millisecond (ms)). For example, the FCC may limit the PSD for UWB communications within the United States to −41.3 dBm/MHz. Accordingly, where the transmission power is averaged over 1 ms for compliance with the PSD limit, there may be a limit on transmitted energy over 1 ms. The PSD limit for UWB communications may limit the physical range of UWB communications and/or the throughput of UWB communications. Bandwidth extension (for example, communication over a bandwidth larger than 500 MHz) may increase the link margin, and therefore may be used to increase the throughput and/or range of UWB communications in view of the PSD limit. Bandwidth extension (such as adoption of larger bandwidths such as 1 GHz or 2 GHz), however, may involve device complexity as communication over such bandwidths may demand RF components at the devices capable of communication over such bandwidths.

Various aspects relate generally to frequency hopping between UWB frequency ranges within a given time duration (for example, 1 ms) to increase the communication range and/or throughput of UWB transmissions. In some aspects, to implement frequency hopping, the transmitting and receiving wireless communication devices may exchange control signaling that indicates or configures a frequency hopping scheme for communication via UWB. For example, the frequency hopping scheme may indicate which frequency ranges (such as, within UWB) will be used for subsequent packets transmitted within a given time duration (such as, a first frequency range for a temporally first packet, a second frequency range for a temporally second packet, etc.) and the relative timing of the subsequent packets. For example, the frequency hopping scheme may indicate the relative timing to enable the wireless communication devices to tune RF circuitry to the different frequency ranges between the subsequent transmissions. In some examples, frequency hopping in UWB may be used for applications such as sensing (for example, presence or location sensing), ranging, and/or data communications.

Particular aspects of the subject matter described in this disclosure can be implemented to realize one or more of the following potential advantages. In some examples, by implementing frequency hopping with UWB communications, the described techniques can be used to increase the range and/or throughput of UWB communications. For example, for a given range, frequency hopping with UWB communications may provide a higher throughput. As another example, for a given data rate, frequency hopping with UWB communications may provide a longer physical communication range. By frequency hopping between UWB frequency ranges, a respective transmission within each frequency band may have a shorter duration and thus may use a higher transmission power while complying with the PSD limit, thereby increasing the communication range and/or throughput by increasing the energy budget. Accordingly, by implementing a frequency hopping scheme in UWB communications, the link budget of UWB communications within a given time duration (for example, within 1 ms) may be increased as compared to communication over a single frequency range within the given time duration. Additionally, or alternatively, by implementing a frequency hopping scheme in UWB communications, frequency diversity may be achieved (for example, which may increase decoding accuracy in cases where one frequency range experiences higher interference and/or noise). In some examples, to increase the throughput of UWB communications, different payloads may be transmitted via the different packets. In some examples, to increase the communication of UWB communications, the data bits may be repeated within the payloads of the packets (for example, the different packets may each include the repetition of data, or each packet may include multiple repetitions of data). In some examples, frequency hopping in UWB communications may be performed in conjunction with multi-millisecond (MMS) coherent combining to further extend the range of communications. For example, payloads transmitted across multiple milliseconds may include repetitions that may be combined to increase the range of communications. For example, frequency hopping schemes as described herein may be repeated across multi-milliseconds (for example, across two or more milliseconds) with the same repetition of packet structure to improve communication range. As another example, packets in subsequent milliseconds transmitted in accordance with frequency hopping schemes as described herein may use different payloads to increase throughput.

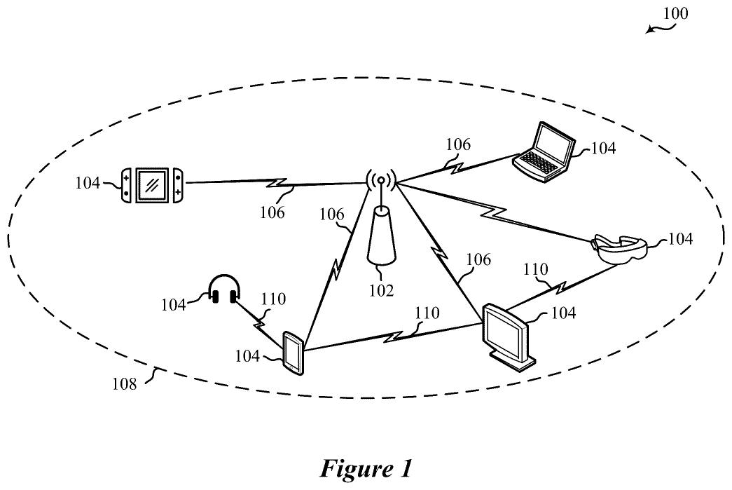

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the 802.11bq Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless AP 102 and any number of wireless STAs 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level A P, a single-frequency A P, a dual-band simultaneous (DBS) AP, a tri-band simultaneous (TBS) AP, a standalone A P, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TV s, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHZ, 5 GHZ, 6 GHz, 45 GHZ, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication
and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some examples, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some examples, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHZ, 5 GHz, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHZ), FR2 (24.25 GHZ-52.6 GHz), FR3 (7.125 GHz-24.25 GHz), FR4a or FR4-1 (52.6 GHz-71 GHz), FR4 (52.6 GHz-114.25 GHz), and FR5 (114.25 GHZ-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHz, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some examples, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TX OP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some examples, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some examples, the M-Primary channel may be used for beaconing and serving legacy client devices and an O-Primary channel may be specifically used by non-legacy (for example, UHR- or IEEE 802.11bn-compatible) devices for opportunistic access to spectrum that may be otherwise under-utilized.

The AP 102 and the STAs 104 of the wireless communication network 100 may implement technologies, protocols or procedures compliant with current and future generations of the IEEE 802.11 family of wireless communication protocol standards, such as Extremely High Throughput (EHT) operation defined by the IEEE 802.11be standard amendment and Ultra-High Reliability (UHR) operation defined by the IEEE 802.11bn standard amendments, to enable additional capabilities or features relative to previous generations, such as devices supporting only legacy operation such as Very High Throughput (VHT) operation defined by the 802.11ac standard amendment or High Efficiency (HE) operation defined by the IEEE 802.11ax standard amendment. For example, the IEEE 802.11be standard amendment introduced 320 MHz channels, which are twice as wide as those possible with the IEEE 802.11ax standard amendment. Accordingly, the AP 102 or the STAs 104 may use 320 MHz channels enabling double the throughput and network capacity, as well as providing rate versus range gains at high data rates due to linear bandwidth versus log SNR trade-off. EHT, UHR or other newer wireless communication protocols may support flexible operating bandwidth enhancements, such as broadened operating bandwidths relative to legacy operating bandwidths or more granular operation relative to legacy operation. For example, an EHT system may allow communications spanning operating bandwidths of 20 MHz, 40 MHz, 80 MHz, 160 MHz, 240 MHz, and 320 MHz while a UHR system may enable communications spanning even greater bandwidths, such as 480 MHz, 640 MHz or greater. EHT systems may, for example, support multiple bandwidth modes such as a contiguous 240 MHz bandwidth mode, a contiguous 320 MHz bandwidth mode, a noncontiguous 160+160 MHz bandwidth mode, or a noncontiguous 80+80+80+80 (or “4×80”) MHz bandwidth mode.

In some examples in which a wireless communication device (such as the AP 102 or the STA 104) operates in a contiguous 320 MHz bandwidth mode or a 160+160 MHz bandwidth mode, signals for transmission may be generated by two different transmit chains of the wireless communication device each having or associated with a bandwidth of 160 MHz (and each coupled to a different power amplifier). In some other examples, two transmit chains can be used to support a 240 MHz/160+80 MHz bandwidth mode by puncturing 320 MHz/160+160 MHz bandwidth modes with one or more 80 MHz subchannels. For example, signals for transmission may be generated by two different transmit chains of the wireless communication device each having a bandwidth of 160 MHz with one of the transmit chains outputting a signal having an 80 MHz subchannel punctured therein. In some other examples in which the wireless communication device may operate in a contiguous 240 MHz bandwidth mode, or a noncontiguous 160+80 MHz bandwidth mode, the signals for transmission may be generated by three different transmit chains of the wireless communication device, each having a bandwidth of 80 MHz. In some other examples, signals for transmission may be generated by four or more different transmit chains of the wireless communication device, each having a bandwidth of 80 MHz.

In noncontiguous examples, the operating bandwidth may span one or more disparate sub-channel sets. For example, the 320 MHz bandwidth may be contiguous and located in the same 6 GHz band or noncontiguous and located in different bands or regions within a band (such as partly in the 5 GHz band and partly in the 6 GHz band).

In some examples, the AP 102 or the STA 104 may benefit from operability enhancements associated with EHT, UHR and newer generations of the IEEE 802.11 family of wireless communication protocol standards. For example, the AP 102 or the STA 104 attempting to gain access to the wireless medium of the wireless communication network 100 may perform techniques (which may include modifications to existing rules, structure, or signaling implemented for legacy systems) such as clear channel assessment (CCA) operation based on EHT or UHR enhancements such as increased bandwidth, puncturing, or refinements to carrier sensing and signal reporting mechanisms.

In some wireless communication systems, wireless communication devices (such as an AP 102 and STAs 104 described with reference to FIG. 1) may operate via one or more wireless communication links in a frequency band higher than a sub-7 GHz (sub7, such as a 2.4 GHz frequency band, a 5 GHz frequency band, or a 6 GHz frequency band) frequency band. In some such wireless communication systems, the AP 102 and STAs 104 may communicate on a wireless communication link in a millimeter wave (“mmWave” or “mmW”) band (for example, a frequency band between 30 GHz and 300 GHz, such as a 60 GHz frequency band). A wireless communication system supporting such mmWave communications (such as AP 102 and STAs 104 in wireless communication network 100) may use integrated mmWave (IMMW) techniques to support operations in these frequency bands. To manage the relatively high attenuation losses and other path losses associated with the mmWave band, the AP 102 and STAs 104 may transmit and receive directional communications via beamforming procedures. To select or otherwise generate directional beams in the mmWave band, a wireless communication device may perform beam sweeping, searching and training operations, which may involve various training and feedback reporting packet sequences. In some wireless communication systems, a mmWave link supports data communications while a sub7 link may be used for management and control information signaling to support the mmWave communications. For example, a STA 104 may first associate with an AP 102 to establish a sub7 link, and thereafter, perform beam searching and training in the mmWave band to establish a mmWave link for the communication of data. In such examples, the sub7 link may be referred to as an anchor link.

In addition to beam searching and training procedures, an AP 102 and a STA 104, after having selected a beam pair, may perform beam management and recovery procedures, including periodic beacon-based procedures and aperiodic STA-initiated fast link recovery procedures, which may involve the use of beam recovery sequences. The AP 102 and STAs 104 may use these beam management and recovery procedures for beam sync-up and identifying broken links. When communicating via a mmWave link, the AP 102 and STAs 104 may perform various channel access procedures including contention-based access procedures, target wake time (TWT)-based access procedures (including the use of dedicated and opportunistic service periods (SPs)), scheduled-mode access procedures, and triggered-mode access procedures. The APs 102 and STAs 104 operating in the mmWave band also may support various management frame optimizations and procedures including optimizations and procedures associated with discovery, scanning, association, roaming, link setup, updates and maintenance, and the initial and continuing configuration of BSS and link-specific parameters including channel selection and rate adaptation. To support or facilitate communication in the mmWave band, the APs 102 and STAs 104 also may make use of various PHY layer enhancements, such as additional bandwidth modes, numerologies, tone plans, preamble designs, codebook designs, waveform designs, new PPDU formats or reuse of existing sub-7 GHz PPDU formats for mmWave frequencies. Particular RF and analog designs, such as RF front end designs, antenna integration designs, and conversion architecture designs, may be implemented in APs 102 and STAs 104 to support mmWave operation.

In some wireless communication systems, wireless communication between an AP 102 and an associated STA 104 can be secured. For example, either an AP 102 or a STA 104 may establish a security key for securing wireless communication between itself and the other device and may encrypt the contents of the data and management frames using the security key. In some examples, the control frame and fields within the MAC header of the data or management frames, or both, also may be secured either via encryption or via an integrity check (for example, by generating a message integrity check (MIC) for one or more relevant fields.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) to enhance various aspects associated with wireless communication. For example, an AI/ML model may be trained to identify patterns or relationships in data observed in a wireless communication network 100. An AI/ML model may support operational decisions implemented by one or more wireless communication devices relating to aspects described herein that are associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

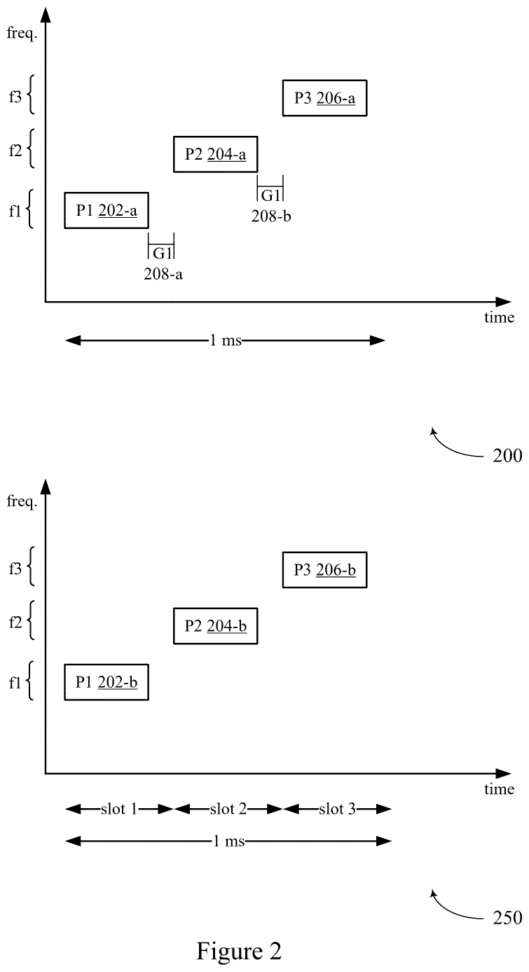

FIG. 2 shows an example of a resource diagram 200 and a resource diagram 250 that support frequency hopping for UWB communications. The resource diagram 200 and the resource diagram 250 may implement or may be implemented by aspects of the wireless communication network 100. For example, the resource diagram 200 and the resource diagram 250 may illustrate communication of a first packet 202, a second packet 204, and/or a third packet 206 between a first wireless communication device and a second wireless communication device. For example, the first wireless communication device (also referred to as a transmitting wireless communication device) and the second wireless communication device (also referred to as a receiving wireless communication device) may be examples of APs 102 or STAs 104 as described herein.

As described herein, wireless communication devices may implement a frequency hopping scheme in UWB communications. For example, as shown in the resource diagram 200 and the resource diagram 250, within a given or configured time duration (for example, 1 ms as shown), a wireless communication device may transmit the first packet 202 via a first frequency range (shown as f1), the second packet 204 via a second frequency range (shown as f2), and the third packet 206 via a third frequency range (shown as f3). In some examples, each frequency range (for example, f1, f2, and f3) may be a 500 MHz frequency range in UWB.

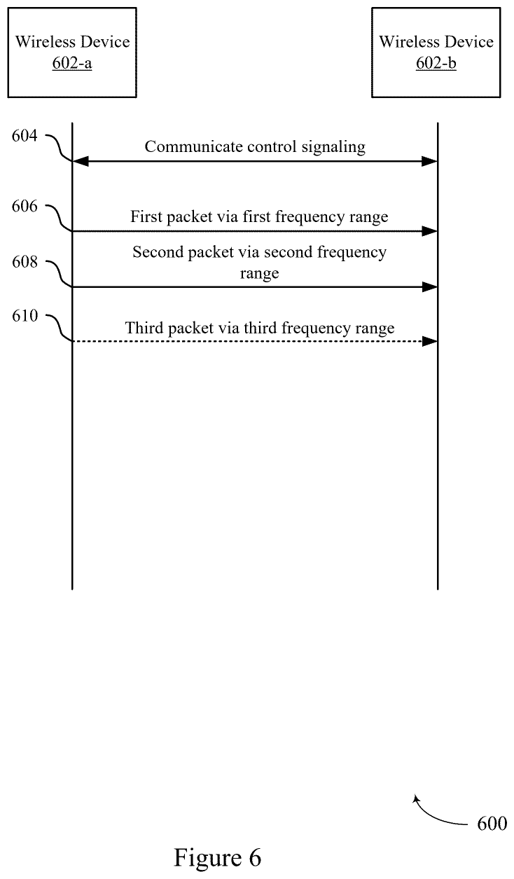

The given or configured time duration may also be referred to as a threshold time duration or a threshold duration. Given a PSD limit for UWB communications that limits the transmission energy per MHz over the given time duration, the frequency hopping scheme may provide a higher throughput (for example, for a given physical communication range) and/or a longer physical communication range (for example, for a given data rate) as compared to transmission over a single frequency range over the given time duration. In some examples, the frequency ranges of the hopping scheme (for example, the first frequency range, the second frequency range, and the third frequency range) may not overlap in order to prevent loss of link margin. In some examples, as shown in the resource diagram 200 and the resource diagram 250, the packets (for example, the first packet 202, the second packet 204, and/or the third packet 206) transmitted within the given time duration in accordance with the frequency hopping scheme may not overlap in time. For example, a time gap between the packets may be used to retune RF circuitry to the next frequency range. For example, a gap of 40 μs may be demanded to retune RF circuitry to the next frequency range. Time gaps between subsequent packets may increase latency, and thus such gap durations may be minimized to reduce latency. As described herein, for example, in accordance with FIG. 6, the wireless communication devices may exchange control signaling (for example, one or more control frames) that may indicate information regarding the frequency hopping scheme to be applied for one or more UWB communications. For example, such control information may include the frequency ranges to be used for each packet in a set of packets within a given time duration and/or the timing between subsequent packets of the set of packets. At the transmitting wireless communication device and the receiving wireless communication device, the time grid may be fixed and known up to a timing drift.

In some examples, as shown in the resource diagram 200, a frequency hopping pattern (also referred to as a frequency hopping scheme) may include a fixed gap duration between subsequent packets transmitted in accordance with the frequency hopping pattern. For example, the first packet 202-a may be transmitted via the first frequency range; the second packet 204-a may be transmitted via the second frequency range a time gap 208-a after an end of the first packet 202-a; and the third packet 206-a may be transmitted via the third frequency range a time gap 208-b after an end of the second packet 204-a, where the time gap 208-a and the time gap 208-b have a fixed duration (which may be the same). Use of a fixed gap duration as shown in the resource diagram 200 may offer higher performance gain but may involve more signaling complexity as compared to use of fixed time slot duration as shown in the resource diagram 250 (for example, to signal the time gap).

In some examples, as shown in the resource diagram 250, a frequency hopping scheme may include a fixed time slot duration, where each packet transmitted in accordance with the frequency hopping scheme is transmitted during a respective time slot. For example, as shown in the resource diagram 250, the first packet 202-b may be transmitted via the first frequency range during a first time slot (shown as slot 1); the second packet 204-b may be transmitted via the second frequency range during a second time slot (shown as slot 2); and the third packet 206-b may be transmitted via the third frequency range during a third time slot (shown as slot 2). The first time slot, the second time slot, and the third time slot may have a fixed time duration. The packet duration may be less than the fixed time duration of the time slots (for example, the duration of the first packet 202-b may be less than the duration of the first time slot, the duration of the second packet 204-b may be less than the duration of the second time slot, and the duration of the third packet 206-b may be less than the duration of the third time slot) to enable tuning to the next frequency range. Accordingly, the fixed time duration of the slots may allow for a gap between an end of a preceding packet and a start of a next/subsequent packet. The fixed time duration of the time slots may be signaled via control signaling between the transmitting and receiving wireless communication devices or may be predefined or standardized.

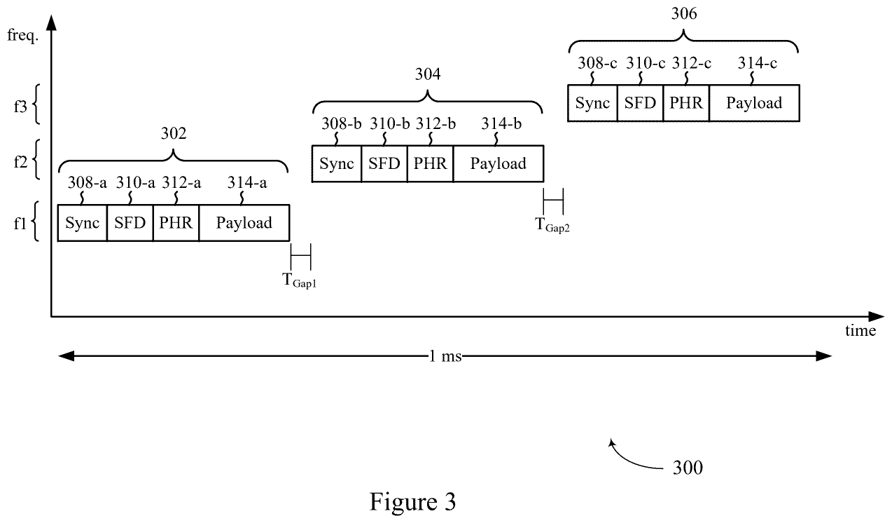

FIG. 3 shows an example of a resource diagram 300 that supports frequency hopping for UWB communications. The resource diagram 300 may implement or may be implemented by aspects of the wireless communication network 100, the resource diagram 200, or the resource diagram 250. For example, the resource diagram 300 may illustrate communication of a first packet 302, a second packet 304, and/or a third packet 306 between a first wireless communication device and a second wireless communication device. For example, the first wireless communication device (also referred to as a transmitting wireless communication device) and the second wireless communication device (also referred to as a receiving wireless communication device) may be examples of APs 102 or STAs 104 as described herein.

As described herein, wireless communication devices may implement a frequency hopping scheme in UWB communications. For example, as shown in the resource diagram 300, within a given or configured time duration (for example, 1 ms as shown), a wireless communication device may transmit the first packet 302 via a first frequency range (shown as f1), the second packet 304 via a second frequency range (shown as f2), and the third packet 306 via a third frequency range (shown as f3). A first time gap shown as T_{Gap1}) may separate the first packet 302 from the second packet 304 (for example, to enable tuning from the first frequency range to the second frequency range). A second time gap (shown as T_{Gap2}) may separate the second packet 304 from the third packet 306 (for example, to enable tuning from the second frequency range to the third frequency range). For example, the time gaps (T_{Gap1} and T_{Gap2}) may be fixed time gaps or may be based on the packets being transmitted within fixed slot durations and the packets having durations shorter than the fixed slot durations. The control signaling that indicates or configured the frequency hopping scheme may indicate such timing information (for example, a fixed gap duration or fixed slot duration) for the time gaps between subsequent packets transmitted in accordance with the frequency hopping scheme.

In some examples, a packet (such as the first packet 302, the second packet 304, and the third packet 306) may include a synchronization portion 308, a start of frame delimiter (SFD) 310, a physical layer header 312, and a data payload 314. The synchronization portion 308 may be used by a receiving wireless communication device (for example, the device that receives the packet) for detection of the corresponding packet and carrier frequency offset (CFO) estimation. In a multi-packet transmission scheme, such as transmission of the first packet 302, the second packet 304, and the third packet 306 in accordance with the frequency hopping scheme, the receiving wireless communication device may use the detection of the temporally first packet (for example, the first packet 302) of the set of packets as the detection of the subsequent packets (for example, the second packet 304 and the third packet 306), as once the receiving wireless communication device detects the temporally first packet of a multi-packet transmission, the receiving wireless communication device may expect the subsequent packets at times and frequencies corresponding to the frequency hopping scheme. Additionally, in a multi-packet transmission scheme, such as transmission of the first packet 302, the second packet 304, and the third packet 306 in accordance with the frequency hopping scheme, the receiving wireless communication device may use the CFO estimate for the temporally first packet (for example, the first packet 302) for adjusting the timing and/or frequencies for receiving and decoding of the subsequent packets (for example, the second packet 304 and the third packet 306). The synchronization portion 308 may also be used by a receiving wireless communication device for channel estimation. The synchronization portion 308 may be demanded for channel estimation in each frequency range, and thus for each packet.

The SFD 310 may indicate the start of a given frame to the receiving wireless communication device. In a multi-packet transmission scheme, such as transmission of the first packet 302, the second packet 304, and the third packet 306 in accordance with the frequency hopping scheme, the receiving wireless communication device may demand an SFD in the temporally first packet (for example, the first packet 302) of the set of packets but may not demand an SFD in a remainder of the packets as the time offset of the remainder of the packets may be known to the receiving wireless communication device based on the frequency hopping scheme. The physical layer header 312 may include control information for the packet (for example, may include field presence and/or length information). In some examples, in the physical layer header 312 in the temporally first packet (for example, the first packet 302) of the set of packets may include control information for the set of packets. Thus, in some examples, the physical layer header 312 may be demanded in the temporally first packet of a set of packets transmitted in accordance with a frequency hopping scheme but may not be demanded in a remainder of the packets. The data payload 314 may include data as described herein.

In some examples, each packet transmitted within a given duration in accordance with a frequency hopping scheme may include a respective synchronization portion 308, a respective SFD 310, a respective physical layer header 312, and a respective data payload 314. For example, the first packet 302 may include a synchronization portion 308-a (that includes sub-portions used for synchronization and detection, CFO estimation, and channel estimation of the first frequency range), an SFD 310-a, a physical layer header 312-a, and a data payload 314-a; the second packet 304 may include a synchronization portion 308-b (that includes sub-portions used for synchronization and detection, CFO estimation, and channel estimation of the second frequency range), an SFD 310-b, a physical layer header 312-b, and a data payload 314-b; and the third packet 306 may include a synchronization portion 308-c (that includes sub-portions used for synchronization and detection, CFO estimation, and channel estimation of the third frequency range), an SFD 310-c, a physical layer header 312-c, and a data payload 314-c.

For example, for a given data rate (for example, 1.95 megabits per second (Mbps) to 124.8 Mbps) and an associated symbol structure, the throughput of UWB communication within a given time duration (for example, 1 ms) may be increased by a factor of N by transmitting NPPDUs (each with different data payloads) in N different frequency ranges (for example, non-overlapping frequency ranges), where the time for each PPDU (T_{PPDU}) plus the time gap (T_{GAP}) between the PPDUs may be less than or equal to the given duration divided by N. For example, T_{PPDU}+T_{Gap}≤1 ms/N. The resource diagram 300 shows an example where N is equal to 3. If each field (for example, a synchronization portion 308 that includes sub-portions used for synchronization and detection, CFO estimation, and channel estimation of the first frequency range, an SFD 310, a physical layer header 312, and a data payload 314) is included in each packet transmitted in accordance with the frequency hopping scheme (for example, the first packet 302, the second packet 304, and the third packet 306), the receiving wireless communication device may perform packet detection, time/frequency estimation, and channel estimation separately per frequency range per time duration (for example, per 1 ms). Such a scenario may involve low airtime efficiency in terms of the airtime used to transmit the data payloads 314. In such cases, where each payload is different in order to increase the throughput, if

$${T}_{P P D U} + {T}_{G a p} \leq \frac{1 ms}{N} ,$$

then the throughput may increase N times, and if

$${T}_{P P D U} + {T}_{G a p} > \frac{1 ms}{N} ,$$

the throughput may decrease proportionally.

As another example, for a given data rate (for example, 1.95 megabits per second (Mbps) to 124.8 Mbps) and an associated symbol structure, the physical transmission range of UWB communication within a given time duration (for example, 1 ms) may be increased by a factor of N by transmitting N PPDUs in N different frequency ranges (for example, non-overlapping) each PPDU with an 1/N data payload duration and each bit of the data payload repeated N times, where to increase the physical transmission range the time for each PPDU (T_{PPDU}) plus the time gap (T_{GAP}) between the PPDUs may be less than or equal to the given duration divided by N. For example,

$${T}_{P P D U} + {T}_{G a p} \leq \frac{1 ms}{N} .$$

Further, to increase the physical transmission range, packet detection may not be the bottleneck for each frequency range.

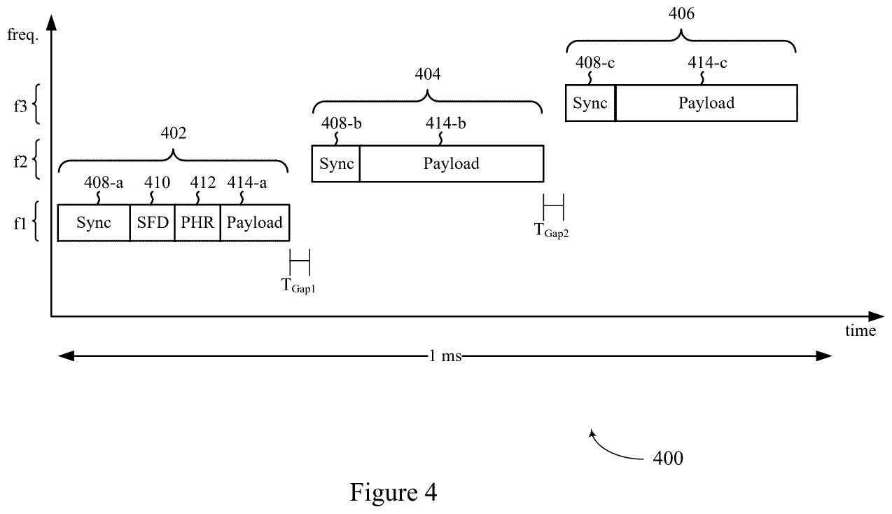

FIG. 4shows an example of a resource diagram 400 that supports frequency hopping for UWB communications. The resource diagram 400 may implement or may be implemented by aspects of the wireless communication network 100, the resource diagram 200, or the resource diagram 250. For example, the resource diagram 400 may illustrate communication of a first packet 402, a second packet 404, and/or a third packet 406 between a first wireless communication device and a second wireless communication device. For example, the first wireless communication device and the second wireless communication device may be examples of APs 102 or STAs 104 as described herein.

As described herein, wireless communication devices may implement a frequency hopping scheme in UWB communications. For example, as shown in the resource diagram 400, within a given or configured time duration (for example, 1 ms as shown), a wireless communication device may transmit the first packet 402 via a first frequency range (shown as f1), the second packet 404 via a second frequency range (shown as f2), and the third packet 406 via a third frequency range (shown as f3). As the data rate decreases, packets may become longer, and thus multiple packets may not fit within a given time duration (for example, 1 ms). A first time gap shown as T_{Gap1}) may separate the first packet 402 from the second packet 404 (for example, to enable tuning from the first frequency range to the second frequency range). A second time gap (shown as T_{Gap2}) may separate the second packet 404 from the third packet 406 (for example, to enable tuning from the second frequency range to the third frequency range). For example, the time gaps (T_{Gap1} and T_{Gap2}) may be fixed time gaps or may be based on the packets being transmitted within fixed slot durations and the packets having durations shorter than the fixed slot durations. The control signaling that indicates or configured the frequency hopping scheme may indicate such timing information (for example, a fixed gap duration or fixed slot duration) for the time gaps between subsequent packets transmitted in accordance with the frequency hopping scheme.

In some examples, overhead (for example, detection, synchronization, channel estimation, and/or control overhead) may be reduced via removal of some fields from the packets after the temporally first packet transmitted within a given duration in accordance with a frequency hopping scheme.

For example, as shown in the resource diagram 400, the first packet 402 may include a synchronization portion 408-a (that includes sub-portions used for synchronization and detection, CFO estimation, and channel estimation of the first frequency range), an SFD 410, a physical layer header 412, and a data payload 414-a. The subsequent packets may include reduced synchronization portions 408 (for example, that include portions for channel estimation but omit portions used for synchronization and detection and CFO estimation) and respective data payloads 414, but may omit SFDs and physical layer headers. For example, the second packet 404 may include a short synchronization portion 408-b (that includes a portion for channel estimation but omits portions used for synchronization and detection and CFO estimation) and a data payload 414-b, and the third packet 406 may include a short synchronization portion 408-c (that includes a portion for channel estimation but omits portions used for synchronization and detection and CFO estimation) and a data payload 414-c. Accordingly, a receiving wireless communication device may perform packet detection and time/frequency estimation for the first packet 402, may perform channel estimation for the first frequency range using the synchronization portion 408-a, may perform channel estimation for the second frequency range using the short synchronization portion 408-b, and may perform channel estimation for the third frequency range using the short synchronization portion 408-c. The receiving wireless communication device may determine the timing of the second packet 404 and the third packet based on detection and timing of the first packet 402 using the synchronization portion 408-a and the timing indicated by the frequency hopping scheme. In some examples, multiple frequency ranges may be dedicated to detection (for example, may include synchronization portions used for detection), and a receiving wireless communication device may perform non-coherent energy combining on the synchronization portions used for detection.

To increase throughput for a given data rate, each of the data payloads 414 may be different and packet detection may not be a performance bottleneck. To increase physical transmission range for a given data rate, each bit of data may be repeated N times across the data payloads 414.

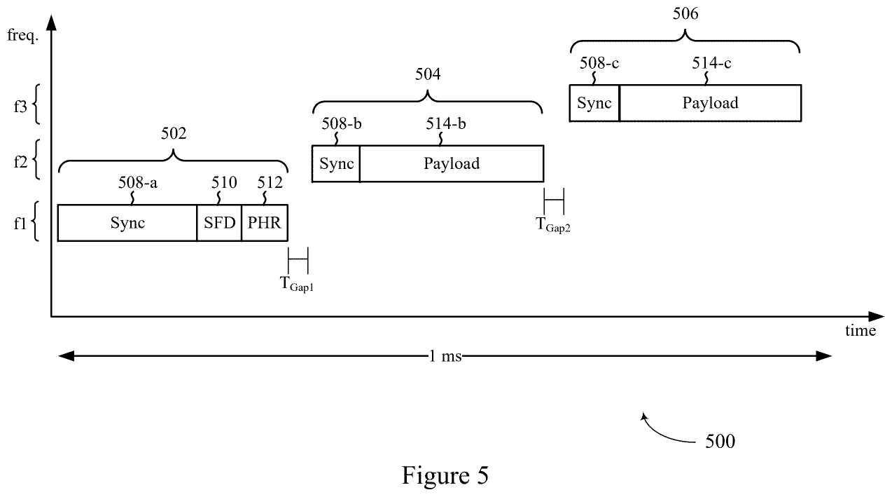

FIG. 5 shows an example of a resource diagram 500 that supports frequency hopping for UWB communications. The resource diagram 500 may implement or may be implemented by aspects of the wireless communication network 100, the resource diagram 200, or the resource diagram 250. For example, the resource diagram 500 may illustrate communication of a first packet 502, a second packet 504, and/or a third packet 506 between a first wireless communication device and a second wireless communication device. For example, the first wireless communication device and the second wireless communication device may be examples of APs 102 or STAs 104 as described herein.

As described herein, wireless communication devices may implement a frequency hopping scheme in UWB communications. For example, as shown in the resource diagram 500, within a given or configured time duration (for example, 1 ms as shown), a wireless communication device may transmit the first packet 502 via a first frequency range (shown as f1), the second packet 504 via a second frequency range (shown as f2), and the third packet 506 via a third frequency range (shown as f3). A first time gap shown as T_{Gap1}) may separate the first packet 502 from the second packet 504 (for example, to enable tuning from the first frequency range to the second frequency range). A second time gap (shown as T_{Gap2}) may separate the second packet 504 from the third packet 506 (for example, to enable tuning from the second frequency range to the third frequency range). For example, the time gaps (T_{Gap1} and T_{Gap2}) may be fixed time gaps or may be based on the packets being transmitted within fixed slot durations and the packets having durations shorter than the fixed slot durations. The control signaling that indicates or configured the frequency hopping scheme may indicate such timing information (for example, a fixed gap duration or fixed slot duration) for the time gaps between subsequent packets transmitted in accordance with the frequency hopping scheme.

As the data rate decreases, packets may become longer, and thus multiple packets may not fit within a given time duration (for example, 1 ms). In some examples, packet detection may become the bottleneck in a scheme that includes detection, synchronization, and control fields in each packet of multiple packets in accordance with a frequency hopping scheme. In some examples, overhead (for example, detection, synchronization, channel estimation, and/or control overhead) may be reduced via dedication of the temporally first packet to detection, synchronization, CFO estimation, and control, and removal of some fields from the packets after the temporally first packet transmitted within a given duration in accordance with a frequency hopping scheme. The remainder of the packets may carry a short synchronization portion for channel estimation and may carry data.

For example, as shown in the resource diagram 500, the first packet 502 may include a synchronization portion 508-a (that includes sub-portions used for synchronization and detection, CFO estimation, and channel estimation of the first frequency range), an SFD 510, and a physical layer header 512 (for example, and may not include a data payload). The subsequent packets may include reduced synchronization portions 508 (for example, that include portions for channel estimation but omit portions used for synchronization and detection and CFO estimation) and respective data payloads 514, but may omit SFDs and physical layer headers. For example, the second packet 504 may include a short synchronization portion 508-b (that includes a portion for channel estimation but omits portions used for synchronization and detection and CFO estimation) and a data payload 514-b, and the third packet 506 may include a short synchronization portion 508-c (that includes a portion for channel estimation but omits portions used for synchronization and detection and CFO estimation) and a data payload 514-c. Accordingly, a receiving wireless communication device may perform packet detection and time/frequency estimation for the first packet 502, may perform channel estimation for the first frequency range using the synchronization portion 508-a, may perform channel estimation for the second frequency range using the short synchronization portion 508-b, and may perform channel estimation for the third frequency range using the short synchronization portion 508-c. The receiving wireless communication device may determine the timing of the second packet 504 and the third packet based on detection and timing of the first packet 502 using the synchronization portion 508-a and the timing indicated by the frequency hopping scheme. In some examples, multiple frequency ranges may be dedicated to detection (for example, may include synchronization portions used for detection), and a receiving wireless communication device may perform non-coherent energy combining on the synchronization portions used for detection.

To increase throughput for a given data rate, each of the data payloads 514 may be different and packet detection may not be a performance bottleneck. To increase physical transmission range for a given data rate, each bit of data may be repeated N times across the data payloads 514.

FIG. 6 shows an example of a process flow 600 that supports frequency hopping for UWB communications. The process flow 600 may implement or may be implemented by aspects of the wireless communication network 100, the resource diagram 200, the resource diagram 250, the resource diagram 300, the resource diagram 400, or the resource diagram 500. For example, a first wireless communication device 602-a may be an example of an AP 102 or a STA 104, and a second wireless communication device 602-b may be an example of an AP 102 or a STA 104. In the following description of the process flow 600, the communications between the first wireless communication device 602-a and the second wireless communication device 602-b may be transmitted in a different order than the example order shown, or the operations performed by the first wireless communication device 602-a and the second wireless communication device 602-b may be performed in different orders or at different times. Some operations may also be omitted from the process flow 600, and other operations may be added to the process flow 600.

At 604, the first wireless communication device 602-a may communicate, with the second wireless communication device 602-b, control signaling that indicates a frequency hopping scheme for UWB communications. The frequency hopping scheme may be indicative of timing of subsequent transmissions via a first frequency range and a second frequency range within a threshold duration. For example, in an uplink scenario where the first wireless communication device 602-a is a STA 104 and the second wireless communication device 602-b is an AP 102, the second wireless communication device 602-b may transmit a control frame that indicates the frequency hopping scheme for the second wireless communication device 602-b to use for uplink communications. As another example, in a downlink scenario where the first wireless communication device 602-a is an AP 102 and the second wireless communication device 602-b is a STA 104, the first wireless communication device 602-a may transmit a control frame that indicates the frequency hopping scheme that the first wireless communication device 602-a will use for downlink communications.

At 606, the first wireless communication device 602-a may transmit (and the second wireless communication device 602-b may receive) a first packet via the first frequency range in accordance with the frequency hopping scheme. In some examples, the control signaling at 604 that indicates the frequency hopping scheme may be included in a control portion (for example, a physical layer header) of the first packet.

At 608, the first wireless communication device 602-a may transmit (and the second wireless communication device 602-b may receive) after a time gap after transmission of the first packet, a second packet via the second frequency range in accordance with the frequency hopping scheme. The transmission of the first packet at 606 and transmission of the second packet at 608 may be within a time period that satisfies the threshold a duration (for example, 1 ms).

In some examples, the timing may involve a fixed gap duration between the subsequent transmissions. For example, the time gap between the transmission of the first packet and the transmission of the second packet may be the fixed gap duration.

In some examples, the timing may involve a fixed time slot duration. For example, the first wireless communication device 602-a may transmit the first packet during a first time slot, and the first wireless communication device 602-a may transmit the second packet during a second time slot, and the timing indicated by the frequency hopping scheme may be the slot duration of the first time slot and the second time slot.

In some examples, the first packet may include a first synchronization portion, a first SFD, a first physical layer header, and a first data payload, the first synchronization portion associated with (for example, used by the second wireless communication device 602-b for) detection of the first packet, CFO estimation, and channel estimation for the first frequency range; and the second packet may include a second synchronization portion, a second SFD, a second physical layer header, and a second data payload, the second synchronization portion associated with (for example, used by the second wireless communication device 602-b for) detection of the second packet, CFO estimation, and channel estimation for the second frequency range. For example, each packet may include full synchronization portions, SFDs, physical layer headers, and data payloads. In some examples, the first data payload may be different than the second data payload (for example, to increase throughput). In some examples (for example, to increase transmission range), the second data payload may be a repetition of the first data payload (for example, where 32 indexed bits are collectively transmitted across the two data payloads of the two packets, the first data payload may include a first repetition of bits 1-32 and the second data payload may include a second repetition of bits 1-32); or the first data payload may include at least two repetitions of a first set of data and the second data payload may include at least two repetitions of a second set of data (for example, where 32 indexed bits are collectively transmitted across the two data payloads of the two packets, the first data payload may include two repetitions of bits indexed 1-16 and the second data payload may include two repetitions of bits indexed 17-32).

In some examples, the first packet may include a first synchronization portion, an SFD, a physical layer header, and a first data payload, the first synchronization portion associated with (for example, used by the second wireless communication device 602-b for) detection of the first packet, CFO estimation, and channel estimation for the first frequency range; and the second packet may include a second synchronization portion and a second data payload, the second synchronization portion associated with (for example, used by the second wireless communication device 602-b for) channel estimation for the second frequency range. For example, to save overhead (and thus increase throughput and/or transmission range) the second packet (and any other subsequent packets within the threshold time duration) may include a short synchronization portion used for channel estimation and may omit SFD(s) and physical layer headers. In some examples, the first data payload may be different than the second data payload (for example, to increase throughput). In some examples (for example, to increase transmission range), the second data payload may be a repetition of the first data payload (for example, where 32 indexed bits are collectively transmitted across the two data payloads of the two packets, the first data payload may include a first repetition of bits 1-32 and the second data payload may include a second repetition of bits 1-32); or the first data payload may include at least two repetitions of a first set of data and the second data payload may include at least two repetitions of a second set of data (for example, where 32 indexed bits are collectively transmitted across the two data payloads of the two packets, the first data payload may include two repetitions of bits indexed 1-16 and the second data payload may include two repetitions of bits indexed 17-32).

In some examples, at 610, first wireless communication device 602-a may transmit (and the second wireless communication device 602-b may receive) after a second time gap after transmission of the second packet, a third packet via a third frequency range in accordance with the frequency hopping scheme. For example, the frequency hopping scheme may be indicative of the timing of subsequent transmissions via the first frequency range, the second frequency range, and the third frequency range. within the threshold duration, and the transmission of the first packet, the transmission of the second packet, and transmission of the third packet may be within the time period that satisfies the threshold duration. In some examples, the first packet may include a first synchronization portion, an SFD, and a physical layer header, the first synchronization portion associated with (for example, used by the second wireless communication device 602-b for) detection of the first packet, CFO estimation, and channel estimation for the first frequency range; the second packet may include a second synchronization portion and a first data payload, the second synchronization portion associated with (for example, used by the second wireless communication device 602-b for) channel estimation for the second frequency range; and the third packet may include a third synchronization portion and a second data payload, the third synchronization portion associated with (for example, used by the second wireless communication device 602-b for) channel estimation for the third frequency range. For example, the first packet may be dedicated to detection, synchronization and control and may omit data, and the subsequent packets may include short synchronization portions used for channel estimation and may omit SFD(s) and physical layer headers. In some examples, the first data payload may be different than the second data payload (for example, to increase throughput). In some examples (for example, to increase transmission range), the second data payload may be a repetition of the first data payload (for example, where 32 indexed bits are collectively transmitted across the two data payloads of the second and third packets, the first data payload may include a first repetition of bits 1-32 and the second data payload may include a second repetition of bits 1-32); or the first data payload may include at least two repetitions of a first set of data and the second data payload may include at least two repetitions of a second set of data (for example, where 32 indexed bits are collectively transmitted across the two data payloads of the second and third packets, the first data payload may include two repetitions of bits indexed 1-16 and the second data payload may include two repetitions of bits indexed 17-32).

In some examples, the first frequency range may be non-overlapping in frequency with the second frequency range. In some examples, the first frequency range may overlap in frequency with the second frequency range. In some examples, more than three frequency ranges may be used to transmit more than three packets within the threshold time duration. The control signaling may indicate the frequency ranges for frequency hopping and the ordering of transmissions of packets within the different frequency ranges in accordance with the frequency hopping scheme.

In some examples, the frequency hopping scheme may be repeated across multiple milliseconds (for example, across two or more milliseconds). For example, in a second threshold duration after the threshold duration (after 608 or after 610) the first packet (with the same payload as the first packet at 606) may be transmitted via the first frequency range and the second packet (with the same payload as the second packet at 608) may be transmitted via the second frequency range, where the first packet and the second packet are separated by the time gap and are within the second threshold duration (such as 1 ms). In such examples, the control signaling at 604 may indicate the quantity of threshold durations (for example, how many milliseconds) the frequency hopping pattern may be repeated. Such a scheme where the packets are repeated across multiple milliseconds in accordance with the frequency hopping scheme may increase communication range. As another example, the frequency hopping scheme may be applied to multiple milliseconds, but with different packets in order to increase throughput and frequency diversity. For example, in a second threshold duration after the threshold duration (after 608 or after 610) a third packet (with a different payload that the first packet at 606) may be transmitted via the first frequency range and a fourth packet (with a different payload that the second packet at 608) may be transmitted via the second frequency range, where the third packet and the fourth packet are separated by the time gap and are within the second threshold duration (such as 1 ms). In such examples, the control signaling at 604 may indicate the quantity of threshold durations (for example, how many milliseconds) the frequency hopping pattern may be applied (for example, may be used).

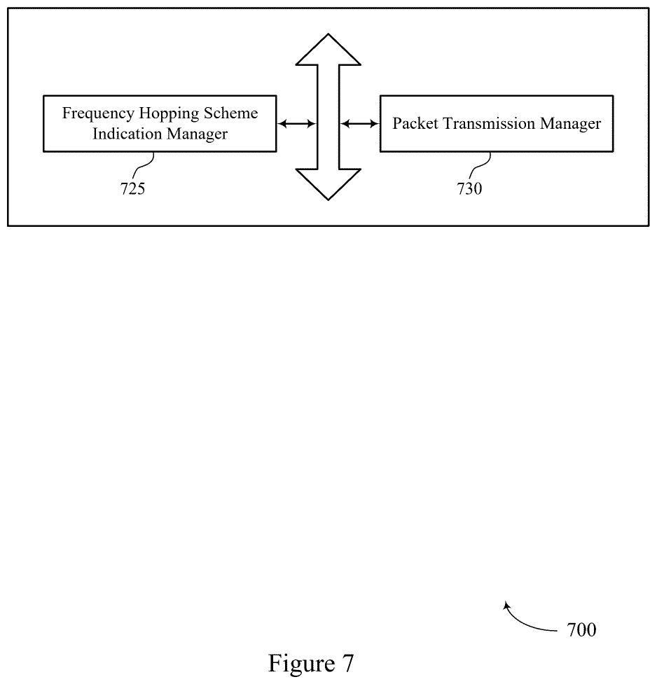

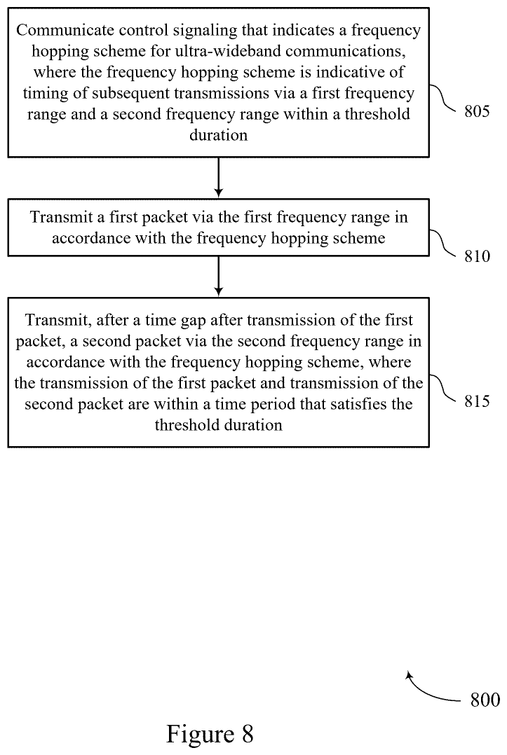

FIG. 7 shows a block diagram of an example wireless communication device 700 that supports frequency hopping for UWB communications. In some examples, the wireless communication device 700 is configured to perform the process 800 described with reference to FIG. 8. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some examples, the wireless communication device 700 can be configurable or configured for use in an AP or STA, such as the AP 102 or the STA 104 described with reference to FIG. 1. In some other examples, the wireless communication device 700 can be an AP or STA that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and M PDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some examples, the wireless communication device 700 also includes or can be coupled with one or more application processors which may be further coupled with one or more other memories. In some examples, the wireless communication device 700 further includes a user interface (UI) (such as a touchscreen or keypad) and a display, which may be integrated with the UI to form a touchscreen display that is coupled with the processing system. In some examples, the wireless communication device 700 may further include one or more sensors such as, for example, one or more inertial sensors, accelerometers, temperature sensors, pressure sensors, or altitude sensors, that are coupled with the processing system. In some examples, the wireless communication device 700 further includes at least one external network interface coupled with the processing system that enables communication with a core network or backhaul network that enables the wireless communication device 700 to gain access to external networks including the Internet.

The wireless communication device 700 includes a frequency hopping scheme indication manager 725 and a packet transmission manager 730. Portions of one or more of the frequency hopping scheme indication manager 725 and the packet transmission manager 730 may be implemented at least in part in hardware or firmware. For example, one or more of the frequency hopping scheme indication manager 725 and the packet transmission manager 730 may be implemented at least in part by at least a processor or a modem. In some examples, portions of one or more of the frequency hopping scheme indication manager 725 and the packet transmission manager 730 may be implemented at least in part by a processor and software in the form of processor-executable code stored in memory.

The wireless communication device 700 may support wireless communications in accordance with examples as disclosed herein. The frequency hopping scheme indication manager 725 is configurable or configured to communicate control signaling that indicates a frequency hopping scheme for UWB communications, where the frequency hopping scheme is indicative of timing of subsequent transmissions via a first frequency range and a second frequency range within a threshold duration. The packet transmission manager 730 is configurable or configured to transmit a first packet via the first frequency range in accordance with the frequency hopping scheme. In some examples, the packet transmission manager 730 is configurable or configured to transmit, after a time gap after transmission of the first packet, a second packet via the second frequency range in accordance with the frequency hopping scheme, where the transmission of the first packet and transmission of the second packet are within a time period that satisfies the threshold duration.

In some examples, the timing includes a fixed gap duration between the subsequent transmissions. In some examples, the time gap includes the fixed gap duration.

In some examples, the packet transmission manager 730 is configurable or configured to transmit the first packet during a first time slot. In some examples, the packet transmission manager 730 is configurable or configured to transmit the second packet during a second time slot, where the timing includes a slot duration of the first time slot and the second time slot.

In some examples, the first packet includes a first synchronization portion, a first SFD, a first physical layer header, and a first data payload, the first synchronization portion associated with detection of the first packet, CFO estimation, and channel estimation for the first frequency range; and the second packet includes a second synchronization portion, a second SFD, a second physical layer header, and a second data payload, the second synchronization portion associated with detection of the second packet, CFO estimation, and channel estimation for the second frequency range.

In some examples, the first data payload is different than the second data payload.

In some examples, the second data payload is a repetition of the first data payload; or the first data payload includes at least two repetitions of a first set of data and the second data payload includes at least two repetitions of a second set of data.

In some examples, the first packet includes a first synchronization portion, an SFD, a physical layer header, and a first data payload, the first synchronization portion associated with detection of the first packet, CFO estimation, and channel estimation for the first frequency range; and the second packet includes a second synchronization portion and a second data payload, the second synchronization portion associated with channel estimation for the second frequency range.

In some examples, the first data payload is different than the second data payload.

In some examples, the second data payload is a repetition of the first data payload; or the first data payload includes at least two repetitions of a first set of data and the second data payload includes at least two repetitions of a second set of data.

In some examples, the packet transmission manager 730 is configurable or configured to transmit, after a second time gap after transmission of the second packet, a third packet via a third frequency range in accordance with the frequency hopping scheme, where: the frequency hopping scheme is indicative of the timing of subsequent transmissions via the first frequency range, the second frequency range, and the third frequency range within the threshold duration; and the transmission of the first packet, the transmission of the second packet, and transmission of the third packet are within the time period that satisfies the threshold duration.

In some examples, the first packet includes a first synchronization portion, an SFD, and a physical layer header, the first synchronization portion associated with detection of the first packet, CFO estimation, and channel estimation for the first frequency range; the second packet includes a second synchronization portion and a first data payload, the second synchronization portion associated with channel estimation for the second frequency range; and the third packet includes a third synchronization portion and a second data payload, the third synchronization portion associated with channel estimation for the third frequency range.

In some examples, the first data payload is different than the second data payload.

In some examples, the second data payload is a repetition of the first data payload; or the first data payload includes at least two repetitions of a first set of data and the second data payload includes at least two repetitions of a second set of data. In some examples, the threshold duration is one millisecond.

In some examples, the first frequency range is non-overlapping in frequency with the second frequency range.

FIG. 8 shows a flowchart illustrating an example process 800 performable by or at a wireless communication device that supports frequency hopping for UWB communications. The operations of the process 800 may be implemented by a wireless communication device or its components as described herein. For example, the process 800 may be performed by a wireless communication device, such as the wireless communication device 700 described with reference to FIG. 7, operating as or within a wireless AP or a wireless STA. In some examples, the process 800 may be performed by a wireless AP or a wireless STA, such as one of the APs 102 or the STAs 104 described with reference to FIG. 1.

In some examples, in 805, the wireless communication device may communicate control signaling that indicates a frequency hopping scheme for UWB communications, where the frequency hopping scheme is indicative of timing of subsequent transmissions via a first frequency range and a second frequency range within a threshold duration. In some implementations, aspects of the operations of 805 may be performed by a frequency hopping scheme indication manager 725 as described with reference to FIG. 7.

In some examples, in 810, the wireless communication device may transmit a first packet via the first frequency range in accordance with the frequency hopping scheme. In some implementations, aspects of the operations of 810 may be performed by a packet transmission manager 730 as described with reference to FIG. 7.

In some examples, in 815, the wireless communication device may transmit, after a time gap after transmission of the first packet, a second packet via the second frequency range in accordance with the frequency hopping scheme, where the transmission of the first packet and transmission of the second packet are within a time period that satisfies the threshold duration. In some implementations, aspects of the operations of 815 may be performed by a packet transmission manager 730 as described with reference to FIG. 7.

Implementation examples are described in the following numbered clauses:

Aspect 1: A method for wireless communications at a wireless communication device, including: communicating control signaling that indicates a frequency hopping scheme for UWB communications, where the frequency hopping scheme is indicative of timing of subsequent transmissions via a first frequency range and a second frequency range within a threshold duration; transmitting a first packet via the first frequency range in accordance with the frequency hopping scheme; and transmitting, after a time gap after transmission of the first packet, a second packet via the second frequency range in accordance with the frequency hopping scheme, where the transmission of the first packet and transmission of the second packet are within a time period that satisfies the threshold duration.

Aspect 2: The method of aspect 1, where the timing includes a fixed gap duration between the subsequent transmissions, and the time gap includes the fixed gap duration.

Aspect 3: The method of any of aspects 1-2, further including: transmitting the first packet during a first time slot; and transmitting the second packet during a second time slot, where the timing includes a slot duration of the first time slot and the second time slot.

Aspect 4: The method of any of aspects 1-3, where: the first packet includes a first synchronization portion, a first SFD, a first physical layer header, and a first data payload, the first synchronization portion associated with detection of the first packet, CFO estimation, and channel estimation for the first frequency range; and the second packet includes a second synchronization portion, a second SFD, a second physical layer header, and a second data payload, the second synchronization portion associated with detection of the second packet, CFO estimation, and channel estimation for the second frequency range.

Aspect 5: The method of aspect 4, where the first data payload is different than the second data payload.

Aspect 6: The method of aspect 4, where the second data payload is a repetition of the first data payload; or the first data payload includes at least two repetitions of a first set of data and the second data payload includes at least two repetitions of a second set of data.

Aspect 7: The method of any of aspects 1-3, where: the first packet includes a first synchronization portion, a SFD, a physical layer header, and a first data payload, the first synchronization portion associated with detection of the first packet, CFO estimation, and channel estimation for the first frequency range; and the second packet includes a second synchronization portion and a second data payload, the second synchronization portion associated with channel estimation for the second frequency range.

Aspect 8: The method of aspect 7, where the first data payload is different than the second data payload.

Aspect 9: The method of aspect 7, where the second data payload is a repetition of the first data payload; or the first data payload includes at least two repetitions of a first set of data and the second data payload includes at least two repetitions of a second set of data.

Aspect 10: The method of any of aspects 1-3, further including: transmitting, after a second time gap after transmission of the second packet, a third packet via a third frequency range in accordance with the frequency hopping scheme, where: the frequency hopping scheme is indicative of the timing of subsequent transmissions via the first frequency range, the second frequency range, and the third frequency range within the threshold duration; and the transmission of the first packet, the transmission of the second packet, and transmission of the third packet are within the time period that satisfies the threshold duration.

Aspect 11: The method of aspect 10, where the first packet includes a first synchronization portion, a SFD, and a physical layer header, the first synchronization portion associated with detection of the first packet, CFO estimation, and channel estimation for the first frequency range; the second packet includes a second synchronization portion and a first data payload, the second synchronization portion associated with channel estimation for the second frequency range; and the third packet includes a third synchronization portion and a second data payload, the third synchronization portion associated with channel estimation for the third frequency range.

Aspect 12: The method of aspect 11, where the first data payload is different than the second data payload.

Aspect 13: The method of aspect 11, where the second data payload is a repetition of the first data payload; or the first data payload includes at least two repetitions of a first set of data and the second data payload includes at least two repetitions of a second set of data.

Aspect 14: The method of any of aspects 1-13, where the threshold duration is one millisecond.

Aspect 15: The method of any of aspects 1-14, where the first frequency range is non-overlapping in frequency with the second frequency range.

Aspect 16: A wireless communication device for wireless communications, including a processing system that includes processor circuitry and memory circuitry that stores code, the processing system configured to cause the wireless communication device to perform a method of any of aspects 1-15.

Aspect 17: A wireless communication device for wireless communications, including at least one means for performing a method of any of aspects 1-15.

Aspect 18: A non-transitory computer-readable medium storing code for wireless communications, the code including instructions executable by one or more processors to perform a method of any of aspects 1-15.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to persons having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

What is claimed is:

1. A wireless communication device, comprising:
a processing system that includes processor circuitry and memory circuitry that stores code, the processing system configured to cause the wireless communication device to:
communicate control signaling that indicates a frequency hopping scheme for ultra-wideband communications, wherein the frequency hopping scheme is indicative of timing of subsequent transmissions via a first frequency range and a second frequency range within a threshold duration;
transmit a first packet via the first frequency range in accordance with the frequency hopping scheme; and
transmit, after a time gap after transmission of the first packet, a second packet via the second frequency range in accordance with the frequency hopping scheme, wherein the transmission of the first packet and transmission of the second packet are within a time period that satisfies the threshold duration.

2. The wireless communication device of claim 1, wherein:
the timing comprises a fixed gap duration between the subsequent transmissions, and
the time gap comprises the fixed gap duration.

3. The wireless communication device of claim 1, wherein the processing system is further configured to cause the wireless communication device to:
transmit the first packet during a first time slot; and
transmit the second packet during a second time slot, wherein the timing comprises a slot duration of the first time slot and the second time slot.

4. The wireless communication device of claim 1, wherein:
the first packet comprises a first synchronization portion, a first start of frame delimiter, a first physical layer header, and a first data payload, the first synchronization portion associated with detection of the first packet, carrier frequency offset estimation, and channel estimation for the first frequency range; and
the second packet comprises a second synchronization portion, a second start of frame delimiter, a second physical layer header, and a second data payload, the second synchronization portion associated with detection of the second packet, carrier frequency offset estimation, and channel estimation for the second frequency range.

5. The wireless communication device of claim 4, wherein the first data payload is different than the second data payload.

6. The wireless communication device of claim 4, wherein:
the second data payload is a repetition of the first data payload; or
the first data payload comprises at least two repetitions of a first set of data and the second data payload comprises at least two repetitions of a second set of data.

7. The wireless communication device of claim 1, wherein:
the first packet comprises a first synchronization portion, a start of frame delimiter, a physical layer header, and a first data payload, the first synchronization portion associated with detection of the first packet, carrier frequency offset estimation, and channel estimation for the first frequency range; and
the second packet comprises a second synchronization portion and a second data payload, the second synchronization portion associated with channel estimation for the second frequency range.

8. The wireless communication device of claim 7, wherein the first data payload is different than the second data payload.

9. The wireless communication device of claim 7, wherein:
the second data payload is a repetition of the first data payload; or
the first data payload comprises at least two repetitions of a first set of data and the second data payload comprises at least two repetitions of a second set of data.

10. The wireless communication device of claim 1, wherein the processing system is further configured to cause the wireless communication device to:
transmit, after a second time gap after transmission of the second packet, a third packet via a third frequency range in accordance with the frequency hopping scheme, wherein:
the frequency hopping scheme is indicative of the timing of subsequent transmissions via the first frequency range, the second frequency range, and the third frequency range within the threshold duration; and
the transmission of the first packet, the transmission of the second packet, and transmission of the third packet are within the time period that satisfies the threshold duration.

11. The wireless communication device of claim 10, wherein:
the first packet comprises a first synchronization portion, a start of frame delimiter, and a physical layer header, the first synchronization portion associated with detection of the first packet, carrier frequency offset estimation, and channel estimation for the first frequency range;
the second packet comprises a second synchronization portion and a first data payload, the second synchronization portion associated with channel estimation for the second frequency range; and
the third packet comprises a third synchronization portion and a second data payload, the third synchronization portion associated with channel estimation for the third frequency range.

12. The wireless communication device of claim 11, wherein the first data payload is different than the second data payload.

13. The wireless communication device of claim 11, wherein:
the second data payload is a repetition of the first data payload; or
the first data payload comprises at least two repetitions of a first set of data and the second data payload comprises at least two repetitions of a second set of data.

14. The wireless communication device of claim 1, wherein:
the threshold duration is one millisecond.

15. The wireless communication device of claim 1, wherein the first frequency range is non-overlapping in frequency with the second frequency range.

16. A method for wireless communications at a wireless communication device, comprising:
communicating control signaling that indicates a frequency hopping scheme for ultra-wideband communications, wherein the frequency hopping scheme is indicative of timing of subsequent transmissions via a first frequency range and a second frequency range within a threshold duration;
transmitting a first packet via the first frequency range in accordance with the frequency hopping scheme; and
transmitting, after a time gap after transmission of the first packet, a second packet via the second frequency range in accordance with the frequency hopping scheme, wherein the transmission of the first packet and transmission of the second packet are within a time period that satisfies the threshold duration.

17. The method of claim 16, wherein:
the timing comprises a fixed gap duration between the subsequent transmissions, and
the time gap comprises the fixed gap duration.

18. The method of claim 16, further comprising:
transmitting the first packet during a first time slot; and
transmitting the second packet during a second time slot, wherein the timing comprises a slot duration of the first time slot and the second time slot.

19. The method of claim 16, wherein:
the first packet comprises a first synchronization portion, a first start of frame delimiter, a first physical layer header, and a first data payload, the first synchronization portion associated with detection of the first packet, carrier frequency offset estimation, and channel estimation for the first frequency range; and
the second packet comprises a second synchronization portion, a second start of frame delimiter, a second physical layer header, and a second data payload, the second synchronization portion associated with detection of the second packet, carrier frequency offset estimation, and channel estimation for the second frequency range.

20. A non-transitory computer-readable medium storing code for wireless communications, the code comprising instructions executable by one or more processors to:
communicate control signaling that indicates a frequency hopping scheme for ultra-wideband communications, wherein the frequency hopping scheme is indicative of timing of subsequent transmissions via a first frequency range and a second frequency range within a threshold duration;
transmit a first packet via the first frequency range in accordance with the frequency hopping scheme; and
transmit, after a time gap after transmission of the first packet, a second packet via the second frequency range in accordance with the frequency hopping scheme, wherein the transmission of the first packet and transmission of the second packet are within a time period that satisfies the threshold duration.
